(19) United States
(12) Patent Application Publication
(10) Pub. No.: US 2015/0305402 A1
(43) Pub. Date: Oct. 29, 2015

(54) CONTAINER WITH MAGNETIC CLOSURE

(71) Applicant: PHILIP MORRIS PRODUCTS S.A., Neuchâtel (CH)

(72) Inventor: Philippe Bourgoin, Echallens (CH)

(21) Appl. No.: 14/648,352

(22) PCT Filed: Dec. 20, 2013
(86) PCT No.: PCT/EP2013/077852

§ 371 Date: May 29, 2015

(30) Foreign Application Priority Data
Dec. 21, 2012 (EP) 12199285.3

(51) Int. Cl. A24F 23/00; B31B 1/90; B31B 1/26; B05D 1/26; B65D 5/66

(52) U.S. Cl. CPC A24F 23/00; B05D 1/26; B05D 1/265; B65D 5/6685; B31B 1/26; B31B 1/90

(57) ABSTRACT

A container (10) for consumer goods formed from at least first and second folded blanks (12, 14), wherein one of the folded blanks is substantially contained within the other folded blank. The container (10) comprises a compartment for receiving consumer goods and a moveable portion defined by the first folded blank. The moveable portion is moveable relative to the second folded blank between a closed position in which consumer goods cannot be removed from the compartment and an open position in which consumer goods can be removed from the compartment. The container (10) further includes a magnetic closure comprising a first magnetic material (24) provided on the moveable portion and a second magnetic material (26) provided on the second folded blank. Each of the first and second magnetic materials (24, 26) has a thickness of between about 0.1 millimetres and about 0.4 millimetres, and the first and second magnetic materials (24, 26) are arranged to overlap each other when the moveable portion is in the closed position so that the magnetic closure releasably retains the moveable portion in the closed position.

The present invention relates to a container for consumer goods, the container having a magnetic closure. The present invention also relates to a method of forming such containers. Containers in accordance with the present invention find particular application as containers for elongate consumer goods, such as smoking articles.

Consumer goods such as smoking articles are commonly packaged in rigid box shaped containers, such as hinge-lid containers and slide-shell containers. Such containers are typically formed from cardboard blanks which are folded to form a complete container. For example, a hinge-lid container typically includes a first blank which is folded to form a box with a lid connected to the box about a hinge line extending across its rear wall, and a second blank which is folded to form an inner frame that is contained within the box. In use, the lid is pivoted about the hinge line to open the container and gain access to a bundle of smoking articles housed in the box. An undesired phenomenon of hinge-lid packs is the “smiling effect”, which denotes a gap between the box part and the lid part that is generally due to resetting forces in the container material in the area of the hinge. These resetting forces prevent complete closure of the pack. A pack that is not completely closable is undesirable as it can lead for example to an inadvertent loss of pack contents, for example, tobacco shorts. In order to overcome the smiling effect, according to the state of the art, the lid typically interacts with the inner frame to maintain the lid in the closed position. For example, the lid may interact with cuts in the inner frame to provide a friction closure

However, closure mechanisms which rely on a friction fit between two or more parts of the container can become unreliable after repeated opening and closing of the container, particularly when the container is formed from a relatively flexible material such as cardboard. For example, the interacting portions of the container can become warped or otherwise damaged after repeated opening and closing of the container. The result is that the closure mechanism may fail and prevent the container from remaining closed, thus giving rise to the smiling effect.

It would be desirable to provide a container for consumer goods, the container having an improved means for retaining the container in a closed state. It would be particularly desirable if such a container could be assembled and filled using conventional high speed methods and apparatus.

The present invention provides a container for consumer goods, the container formed from at least first and second folded blanks, wherein one of the folded blanks is substantially contained within the other folded blank. The container comprises a compartment for receiving consumer goods and a moveable portion defined by the first folded blank. The moveable portion is moveable relative to the second folded blank between a closed position in which consumer goods cannot be removed from the compartment and an open position in which consumer goods can be removed from the compartment. The container further includes a magnetic closure comprising a first magnetic material provided on the moveable portion and a second magnetic material provided on the second folded blank. Each of the first and second magnetic materials has a thickness of between about 0.1 millimetres and about 0.4 millimetres, and the first and second magnetic materials are arranged to overlap each other when the moveable portion is in the closed position so that the magnetic closure releasably retains the moveable portion in the closed position.

The present invention also provides a method of forming such a container. Accordingly, the present invention provides a method of forming a container for consumer goods, the method comprising a first step of providing first and second laminar blanks. A first magnetic material is applied on the first laminar blank, the first magnetic material having a thickness of between about 0.1 millimetres and about 0.4 millimetres. A second magnetic material is applied on the second laminar blank, the second magnetic material having a thickness of between about 0.1 millimetres and about 0.4 millimetres. The first and second laminar blanks are folded to form first and second folded blanks, wherein one of the folded blanks is substantially contained within the other folded blank. The folded blanks co-operate to form a container comprising a compartment for receiving consumer goods. At least a portion of the first folded blank is moveable relative to the second folded blank between a closed position in which consumer goods cannot be removed from the compartment and an open position in which consumer goods can be removed from the compartment. The first magnetic material is applied on the moveable portion defined by the first folded blank and the first and second magnetic materials are arranged to overlap each other when the moveable portion is in the closed position so that the first and second magnetic materials form a magnetic closure that releasably retains the moveable portion in the closed position.

The term “magnetic material” is used herein to describe a material which is able to interact with a magnetic field, including both paramagnetic and ferromagnetic materials. A magnetisable material may be a paramagnetic material, such that it only remains magnetised in the presence of an external magnetic field. Alternatively, a magnetisable material may be a material which becomes magnetised in the presence of an external magnetic field and which remains magnetised after the external field is removed (a ferromagnetic material, for example). The term “magnetic material” as used herein encompasses both types of magnetisable material, as well as material which is already magnetised.

The term “substantially contained within” is used herein to mean a container in which the outer folded blank overlies, in direct contact or spaced from the inner folded blank, all external surfaces of the inner folded blank at least partially when the container is closed, or, where the inner folded blank comprises three or more outer surfaces, the outer folded blank overlies at least three surfaces of the inner folded blank when the container is closed. For example, in embodiments in which the container is a hinge-lid container, the second folded blank may form an inner frame which is completely contained within a box portion formed by the first folded blank. In another example, the outer folded blank may be a sleeve of a slide and shell container that overlies at least partially four sides of the inner slide.

The term “inner surface” is used throughout the specification to refer to the surface of a component of the assembled container that is facing towards the interior of the container, for example towards the consumer goods, when the filled container is in the closed position. Likewise, the term “outer surface” is used throughout the specification to refer to the surface of a component of the container that is facing towards the exterior of the container. For example, the inner frame of a hinge-lid container comprises an outer surface that is facing the outer housing of the container and an inner surface that is facing the inner package of the container. It should be noted that the inside or outside surface is not necessarily equivalent to a certain side of a blank used in assembly of the container. Depending on how the blank is folded around the consumer goods, areas that are on the same side of the container can either face towards the inside or the towards the outside of the container.

By applying magnetic materials on the first and second folded blanks, the present invention provides containers each having a magnetic closure that provides a reliable means for maintaining the moveable portion in the closed position, even after repeated opening and closing of the container. In addition, the magnetic materials can be applied with minimal or no modification to existing blanks, such that existing processes and apparatus can be used to form the containers.

For ease of manufacture of the container, the first and second magnetic materials are preferably applied directly onto the first and second blanks using a suitable application process, such as a printing process or an extrusion coating process. For example, at least one of the first and second magnetic materials may be applied using gravure printing, offset printing, flexographic printing, lithographic printing, screen printing, slot die coating, roll coating or reverse roll coating, knife-over-roll gravure and reverse direct gravure, wire rod coating, air-knife coating, or slot-orifice coating. The first and the second magnetic materials may be applied in a single layer process or in a multilayer process. For example, to achieve a higher layer thickness, two, three, four or more subsequent layers may be applied.

During the steps of applying the first and second magnetic materials to the blanks, each of the first and second magnetic materials may be provided in a composition which is liquid at room temperature. However, each of the first and second magnetic materials is preferably provided in the form of a composition which is heatable to form a molten composition for application to the blanks. Use of such a composition can provide improved adhesion of the magnetic material to the blanks. Preferably, each composition comprises about 70 weight percent to about 95 weight percent of at least one magnetic material and about 5 weight percent to about 30 weight percent of at least one thermoplastic binder. Suitable thermoplastic binders include thermoplastic elastomers, thermoplastic non-elastomeric polymers and mixtures thereof.

In any of the embodiments described above, the first and second magnetic materials may comprise the same magnetic material or different magnetic materials. Furthermore, the first and second materials may each comprise a single magnetic material or a mixture of different magnetic materials. Suitable magnetic materials include barium ferrite, strontium ferrite cobalt ferrite, rare earth cobalt materials (samarium pentacobalt, praseodymium pentacobalt, yttrium pentacobalt, lanthanum pentacobalt, and cerium-pentacobalt, for example), manganese-bismuth, and manganese-aluminium.

Once applied to the first and second blanks, each of the first and second magnetic materials has a thickness of between about 0.1 millimetres and about 0.4 millimetres, preferably between about 0.2 millimetres to about 0.4 millimetres. Advantageously, layers of magnetic material having a thickness within these ranges are thick enough to provide sufficient magnetic field strength for an effective closure, whilst remaining thin enough to eliminate the need for significant modification to existing container designs.

To prevent undesired attraction of the magnetic material to external ferromagnetic materials (production apparatus, for example) during the manufacturing process, the first and second magnetic materials are preferably magnetisable materials that are unmagnetised during the steps of applying the magnetic materials to the blanks. In this case, each of the first and second magnetic materials preferably comprises at least one ferromagnetic material. After the unmagnetised first and second magnetic materials have been applied to the blanks, at least one of the magnetic materials is subsequently magnetised to form the magnetic closure. The step of magnetising one or both of the first and second magnetic materials can be carried out at any subsequent stage of the manufacture process. For example, the magnetisation step could be conducted before the folding step, after the folding step but before filling the container with consumer goods, after filling the container with consumer goods but before wrapping the filled container, or after wrapping the filled container. The magnetisation step can be carried out by bringing one or both of the first and second magnetic materials into proximity of a permanent magnet or an electromagnet, for example.

In embodiments in which at least one of the first and second magnetic materials is applied to the blanks as an unmagnetised magnetisable material, the magnetisation step may magnetise only a portion of the magnetisable material to form the magnetic closure. Advantageously, this arrangement can eliminate the need for accurate registration between the steps of applying the magnetic material and folding the blanks, since the magnetic closure is formed only after the folding step has been completed. For example, at least one of the first and second magnetic materials can be applied as an unmagnetised magnetisable material over an entire surface of the respective blank, which can minimise or eliminate the need for registration with the blanks during the application step. After the folding step has been completed, the exact location of the magnetic closure is determined and the appropriate portion of the magnetisable material is magnetised to form the closure.

The first and second magnetic materials will function together as a magnetic closure if only one of the magnetic materials is magnetised, provided the other magnetic material comprises a magnetisable material. In those embodiments in which both the first and the second magnetic materials are magnetised, the magnetic fields of the two magnetic materials must be arranged to reinforce each other when the moveable portion is in the closed position so that the two magnetic materials are attracted to each other.

To minimise the visual impact of the first and second magnetic materials provided on the container, one or both of the magnetic materials can be applied to the blanks in the form of a composition having a colour which matches the colour of the blank or matches a design provided on the blank in the region onto which the magnetic material is applied. The colour of the composition may be the same as the colour on the blank or may contrast the surrounding colour on the blank; preferably, the magnetic materials appear to form part of the overall design of the blank.

As an alternative to providing a composition having the required colour, one or more inks having the appropriate colour can be printed or otherwise applied over one or both of the magnetic materials after they have been applied to the blanks. Therefore, in some embodiments, the method further comprises a step of printing at least one ink onto at least one of the first and second magnetic materials after the applying step. Similarly, in some embodiments, the container may comprise at least one ink applied over at least one of the first and second magnetic materials. In some embodiments a primer may be applied to the magnetic material to facilitate the application of the printed ink onto the magnetic material.

As a further alternative to matching the colour of the first and second magnetic materials to the colour of the blanks onto which they are applied, one or both of the magnetic materials can be provided on a portion of the blank which will be obscured from view once the blanks have been folded and assembled to form the container. For example, one or both of the magnetic materials can be provided on a portion of the first or second blank such that the magnetic material will be contained within a fold once the blanks have been folded. That is, one or both of the magnetic materials can be positioned between two overlapping portions of the blanks once the blanks have been folded and assembled. The two overlapping portions may be two portions of the same folded blank, or they may comprise a portion of each of the first and second blanks.

In preferred embodiments, the interacting surfaces of magnetic material on the first and second blanks are in contact with each other when the container is closed. That is, there is preferably no intervening material between the interacting surfaces of magnetic material on the first and second blanks when the container is closed, other than any ink which may be applied over the magnetic materials as described above.

As discussed above, containers in accordance with the present invention may be of a hinged lid design such that the container comprises a lid pivotable along a hinge line, between a closed position and an open position in which consumer goods can be removed from the container. Preferably, the hinge line extends across a rear wall of the container such that the lid also includes a portion of the rear wall.

As well as hinged lid containers, the skilled person will appreciate that the present invention can be applied to containers of alternative design, such as containers having a sliding mechanism for opening the container.

In any of the embodiments described above, the container is preferably filled with smoking articles. However, containers in accordance with the present invention can also be used with a variety of consumer goods other than smoking articles.

Containers according to the present invention are preferably rectangular parallelepipeds each comprising two wider walls spaced apart by two narrower walls. The two wider walls will usually be the front and rear walls and the two narrower walls will usually be side walls.

The containers may be formed from any suitable materials including, but not limited to, cardboard, paperboard, plastic, metal, or combinations thereof. Preferably, the containers are formed from two folded laminar cardboard blanks, wherein the cardboard preferably has a basis weight of between about 100 grams per square metre and about 350 grams per square metre.

In some embodiments, each assembled and filled container is wrapped in an outer wrapper. The outer wrapper is preferably a transparent polymeric film of, for example, high or low density polyethylene, polypropylene, oriented polypropylene, polyvinylidene chloride, cellulose film, or combinations thereof and the outer wrapper is applied in a conventional manner. The outer wrapper may include a tear tape. In addition, the outer wrapper may be printed with images, consumer information or other data.

As described above, containers according to the invention may be in the shape of a rectangular parallelepiped and may comprise right-angled longitudinal and right-angled transverse edges. Alternatively, the containers may comprise one or more rounded longitudinal edges, rounded transverse edges, bevelled longitudinal edges or bevelled transverse edges, or combinations thereof.

Where the container comprises one or more bevelled edges, preferably the bevelled edge has a width of between about 1 mm and about 10 mm, preferably between about 2 and about 6 mm. Alternatively, the container may comprise a double bevel formed by three parallel creasing or scoring lines that are spaced such that two distinct bevels are formed on the edge of the container.

Alternatively, the container may have a non-rectangular transversal cross section, for example polygonal such as triangular or hexagonal, semi-oval or semi-circular.

As described above, containers according to the invention find particular application as packs for elongate smoking articles such as, for example, cigarettes, cigars or cigarillos. It will be appreciated that through appropriate choices of the dimensions, containers according to the invention may be designed for different numbers of conventional size, king size, super-king size, slim or super-slim cigarettes. Alternatively, other consumer goods may be housed inside the packages and containers.

Through an appropriate choice of the dimensions of the containers according to the present invention, they may be designed to hold different total numbers of smoking articles, or different arrangements of smoking articles. For example, through an appropriate choice of the dimensions thereof, containers according to the invention may be designed to hold a total of between five and thirty smoking articles.

The smoking articles may be arranged in different collations, depending on the total number of smoking articles. For example, the smoking articles may be arranged in a single row of five, six, seven, eight, nine or ten. Alternatively, the smoking articles may be arranged in two or more rows. The two or more rows may contain the same number of smoking articles. For example, the smoking articles may be arranged in: two rows of five, six, seven, eight, nine or ten; three rows of five or seven; or four rows of four, five or six. Alternatively, the two or more rows may include at least two rows containing different numbers of smoking articles to each other.

Containers according to the present invention may hold smoking articles of the same type or brand, or of different types or brands. In addition, both filterless smoking articles and smoking articles with various filter tips may be contained, as well as smoking articles of differing length (for example, between about 40 mm and about 180 mm), diameter (for example, between about 4 mm and about 9 mm). In particular, the container may comprise smoking articles with recessed filters. In addition, the smoking articles may differ in strength of taste, resistance to draw and total particulate matter delivery. Preferably, the dimensions of the containers are adapted to the length of the smoking articles, and the collation of the smoking articles. Typically, the dimensions of the container are between about 0.5 mm to about 5 mm larger than the dimensions of the package or packages of smoking articles housed inside the container.

Preferably, containers according to the invention have a width of between about 12 mm and about 150 mm, more preferably a width of between about 40 mm and about 125 mm, wherein the width is measured from one side wall to the other side wall of the container.

Preferably, containers according to the invention have a depth of between about 6 mm and about 150 mm, more preferably a depth of between about 12 mm and about 25 mm wherein the depth is measured from the front wall to the rear wall of the container.

Preferably, the ratio of the height of the container to the depth of the container is in between about 0.3 to 1 and about 10 to 1, more preferably between about 2 to 1 and about 8 to 1, most preferably between about 3 to 1 and 5 to 1.

Preferably, the ratio of the width of the container to the depth of the container is in between about 0.3 to 1 and about 10 to 1, more preferably between about 2 to 1 and about 8 to 1, most preferably between about 2 to 1 and 3 to 1.

Where the container houses smoking articles, the container may further comprise compartments (for example for waste such as ash or butts) or other consumer goods, for example matches, lighters, extinguishing means, breath-fresheners or electronics. The other consumer goods may be attached to the outside of the container, contained within the container along with the smoking articles, in a separate compartment of the container or combinations thereof.

The exterior surfaces of containers according to the invention may be printed, embossed, debossed or otherwise embellished with manufacturer or brand logos, trademarks, slogans and other consumer information and indicia. As described above, the first and second magnetic materials may be formed from an appropriate colour or overprinted in an appropriate colour such that the first and second magnetic materials blend into the design of the container.

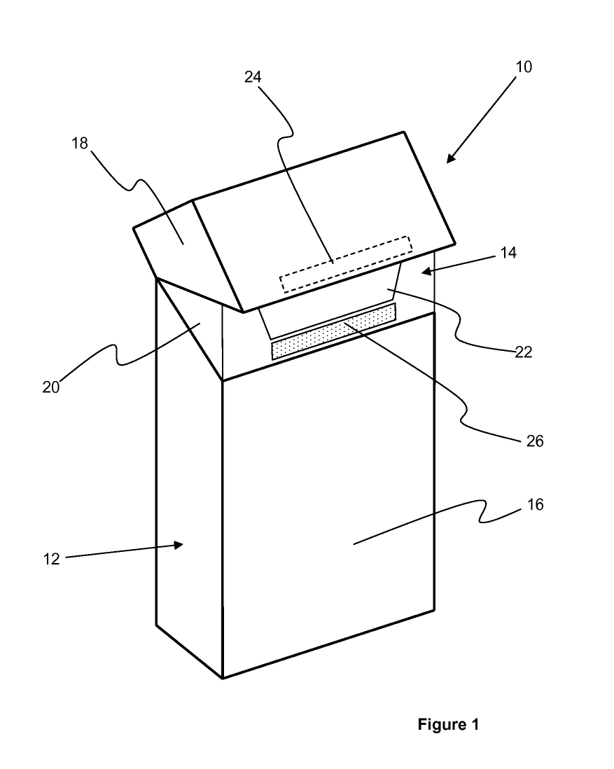

The invention will now be described further, by way of example only, with reference to the accompanying drawing in which FIG. 1 shows a container 10 formed in accordance with the present invention.

The container 10 is formed from an outer blank 12 and an inner blank 14. The outer blank 12 is folded to form a box portion 16 and a lid portion 18, the lid portion 18 being connected to the box portion 16 by a hinge line extending across the back wall of the outer blank 12.

The inner blank 14 is folded to form an inner frame 20 which is contained within the outer blank 12. The inner frame 20 includes a cut-out 22 formed therein for accessing the consumer goods contained within the inner frame 20. The inner frame 20 may also include a flap for covering the cut-out 22 when the container 10 is closed.

The container 10 also includes a magnetic closure comprising a first magnetic material 24 applied to an inner surface of the lid portion 18 and a second magnetic material 26 applied to an outer surface of the inner frame 20. At least one of the magnetic materials is magnetised, and the other magnetic material is magnetised or magnetisable. If both magnetic materials are magnetised, the magnetic fields of both magnetic materials should act to reinforce each other so that the two magnetic materials are attracted to each other and retain the lid portion 18 in the closed position when the container 10 is closed.

1. A container for consumer goods, the container formed from at least first and second folded blanks, wherein one of the folded blanks is substantially contained within the other folded blank, the container comprising:
a compartment for receiving consumer goods;
a moveable portion defined by the first folded blank and moveable relative to the second folded blank between a closed position in which consumer goods cannot be removed from the compartment and an open position in which consumer goods can be removed from the compartment; and
a magnetic closure comprising a first magnetic material provided on the moveable portion and a second magnetic material provided on the second folded blank, wherein each of the first and second magnetic materials has a thickness of between about 0.1 millimetres and about 0.4 millimetres, and wherein the first and second magnetic materials are arranged to overlap each other when the moveable portion is in the closed position so that the magnetic closure releasably retains the moveable portion in the closed position,
wherein one of the first and second magnetic materials comprises a magnetised material and wherein only a portion of the magnetisable material is magnetised.

2. A container according to claim 1, wherein the first and second magnetic materials comprise the same magnetic material.

3. A container according to claim 1, wherein each of the first and second magnetic materials comprises at least one of barium ferrite, strontium ferrite, cobalt ferrite, and a rare earth cobalt.

4. A container according to claim 1, wherein one of the first and second magnetic materials comprises a magnetised material and the other comprises a magnetisable material.

5. (canceled)

6. A container according to claim 1, further comprising at least one ink applied over at least one of the first and second magnetic materials.

7. A container according to claim 1, wherein the container is filled with a plurality of smoking articles.

8. A method of forming a container for consumer goods, the method comprising:
providing first and second laminar blanks;
applying a first magnetic material on the first laminar blank, the first magnetic material having a thickness of between about 0.1 millimetres and about 0.4 millimetres;
applying a second magnetic material on the second laminar blank, the second magnetic material having a thickness of between about 0.1 millimetres and about 0.4 millimetres; and
folding the first and second laminar blanks to form first and second folded blanks, wherein one of the folded blanks is substantially contained within the other folded blank, the folded blanks co-operating to form a container comprising a compartment for receiving consumer goods, at least a portion of the first folded blank being moveable relative to the second folded blank between a closed position in which consumer goods cannot be removed from the compartment and an open position in which consumer goods can be removed from the compartment;
wherein the first magnetic material is applied on the moveable portion and wherein the first and second magnetic materials are arranged to overlap each other when the moveable portion is in the closed position so that the first and second magnetic materials form a magnetic closure that releasably retains the moveable portion in the closed position,
wherein the first and second magnetic materials are magnetisable materials and wherein the first and second magnetisable materials are unmagnetised during the applying steps.

9. A method according to claim 8, wherein at least one of the applying steps comprises applying the magnetic material on the laminar blank using gravure printing, offset printing, flexographic printing, lithographic printing, screen printing, slot die coating, roll coating or reverse roll coating, knife-over-roll gravure and reverse direct gravure, wire rod coating, air-knife coating, or slot-orifice coating.

10. A method according to claim 8, wherein the first and second magnetic materials comprise the same magnetic material.

11. A method according to claim 8, wherein each of the first and second magnetic materials comprises at least one of barium ferrite, strontium ferrite, cobalt ferrite, and a rare earth cobalt.

12. (canceled)

13. A method according to claim 8, further comprising a step of, after the folding step, magnetising at least one of the first and second magnetisable materials to form a permanent magnet.

14. A method according to claim 13, wherein the magnetising step magnetises only a portion of at least one of the first and second magnetisable materials.

15. A method according to claim 8, further comprising a step of printing at least one ink onto at least one of the first and second magnetic materials after the applying step.

16. A container according to claim 2, wherein each of the first and second magnetic materials comprises at least one of barium ferrite, strontium ferrite, cobalt ferrite, and a rare earth cobalt.

17. A container according to claim 2, wherein at least one of the first and second magnetic materials is a magnetisable material and wherein only a portion of the magnetisable material is magnetised.

18. A container according to claim 3, wherein at least one of the first and second magnetic materials is a magnetisable material and wherein only a portion of the magnetisable material is magnetised.

19. A method according to claim 9, wherein the first and second magnetic materials comprise the same magnetic material.

20. A method according to claim 9, wherein each of the first and second magnetic materials comprises at least one of barium ferrite, strontium ferrite, cobalt ferrite, and a rare earth cobalt.

21. A method according to claim 10, wherein each of the first and second magnetic materials comprises at least one of barium ferrite, strontium ferrite, cobalt ferrite, and a rare earth cobalt.

22. A method according to claim 13, further comprising a step of printing at least one ink onto at least one of the first and second magnetic materials after the applying step.
